(19) United States
(12) Patent Application Publication
(10) Pub. No.: US 2003/0043845 A1
(43) Pub. Date: Mar. 6, 2003

(54) Home appliance data transfer system and method for controlling the same

(76) Inventors: Hyung Tack Lim, Euiwang-si (KR); II Hoon Ji, Seoul (KR)

Correspondence Address: BIRCH STEWART KOLASCH & BIRCH, PO BOX 747, FALLS CHURCH, VA, 22040-0747, US

(21) Appl. No.: 10/156,822

(22) Filed: May 30, 2002

(30) Foreign Application Priority Data
Sep. 3, 2001 (KR) 2001-53901

(51) Int. Cl. H04J 3/16

(52) U.S. Cl. 370/466

(57) ABSTRACT

A home appliance data transfer system and a method for controlling the same, wherein a Java phone is connected to a home appliance via their serial ports to transmit and receive data to/from the home appliance. Control data that a user desires to input to the home appliance can be transferred to the appliance under the condition that no IP address is set in the appliance. A Java application of the Java phone supports a transfer application which converts data according to a data transfer standard of the Java phone and home appliance. Therefore, the home appliance and Java phone can transmit and receive data without collision and the user can conveniently input data to the home appliance.

### BACKGROUND OF THE INVENTION

1. Field of the Invention

The present invention relates to home appliance data transfer systems and methods for controlling the same, and more particularly to a home appliance data transfer system and a method for controlling the same, wherein a user can easily transfer data to a home appliance with no necessity for setting an Internet protocol (IP) address in the home appliance.

2. Description of the Related Art

Recently, home appliances connectable to the Internet and controllable by users outside of their homes have been significantly increasingly used.

Such home appliances are generally equipped with communication modules, such as local area network (LAN) cards or modems, so as to be connectable to the Internet, transmit and receive information to/from the Internet and be controllable over the Internet. Also, home appliances connected to the Internet transmit information regarding their operating states to the Internet, so that users of the home appliances can monitor the operating states of the appliances over the Internet.

However, for connection of home appliances to the Internet, IP addresses must be set respectively in the home appliances, besides the installation of separate communication modules in the appliances as mentioned above, thereby increasing manufacturing costs of the appliances and in turn reducing the competitiveness of the appliances in the market place.

In order to avoid the above problems, a system has been developed and used which, without installing communication modules in home appliances, connects the home appliances to a personal computer (PC) usually used in a home and in turn connects them to the Internet through the PC, and then controls the appliances over the Internet.

However, because the PC is a computing device fixed in one specific place, a user must always inconveniently move to the specific place to control the home appliances using the PC. In order to remove this inconvenience, a cellular phone-based home appliance control system has recently been proposed which connects a home appliance to a cellular phone and transfers control information to the home appliance through the cellular phone to control the appliance.

In the cellular phone-based home appliance control system as mentioned above, the control information must be transmitted and received between the cellular phone and the home appliance according to a predetermined data transmission/reception protocol. However, the cellular phone and the home appliance have different data transmission/reception standards, so they are not compatible with each other.

### SUMMARY OF THE INVENTION

Therefore, the present invention has been made in view of the above problems, and it is an object of the present invention to provide a home appliance data transfer system and a method for controlling the same, wherein a Java application used in a Java phone which transfers data to a home appliance supports a data transfer application of the Java phone to enable the transfer of data between the Java phone and the appliance.

In accordance with one aspect of the present invention, the above and other objects can be accomplished by the provision of a home appliance data transfer system comprising: at least one home appliance for converting data to be transmitted and received via a serial port appropriately to a transfer standard to enable data transmission/reception based on a serial communication standard; and at least one Java phone connected to the home appliance, the Java phone having a Java application installed therein, the Java application supporting a transfer application of the Java phone which converts data to be transferred to the home appliance appropriately to the transfer standard.

In accordance with another aspect of the present invention, there is provided a method for controlling a home appliance data transfer system, comprising the steps of: a) connecting at least one Java phone to at least one home appliance to input data to the home appliance; b) converting data to be transferred from the Java phone to the home appliance appropriately to a transfer standard; c) transferring the data converted at the step b) to the home appliance; and d) converting the data transferred at the step c) appropriately to a standard of the home appliance and controlling the appliance according to the converted data.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the construction of a home appliance data transfer system in accordance with the present invention;

FIG. 2 is a view showing the structure of a packet used in the home appliance data transfer system in accordance with the present invention; and

FIG. 3 is a flow chart illustrating a method for controlling the home appliance data transfer system in accordance with the present invention.

### DESCRIPTION OF THE PREFERRED EMBODIMENTS

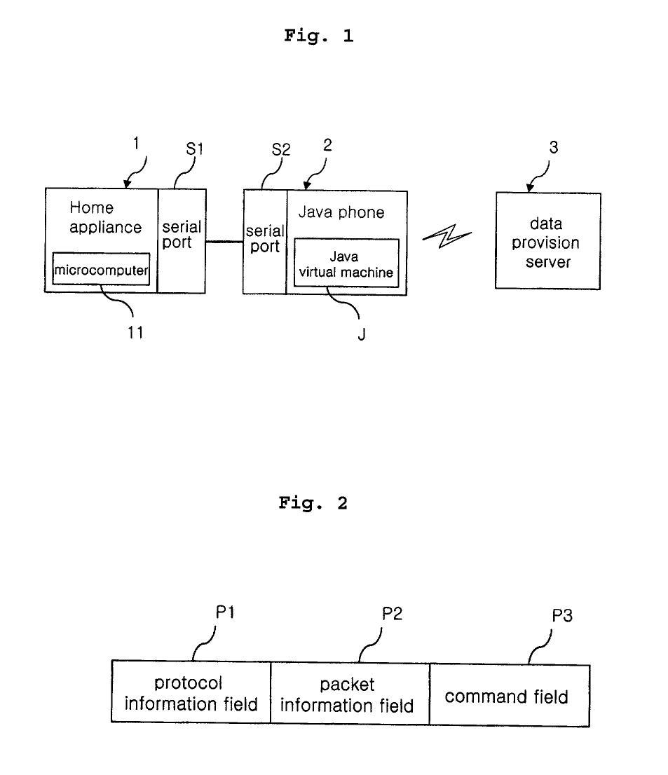

With reference to FIG. 1, there is shown in block form the construction of a home appliance data transfer system in accordance with the present invention. As shown in this drawing, the home appliance data transfer system comprises a home appliance 1 having a serial port S1 for transmitting and receiving data, a Java phone 2 for transferring data selected by a user to the home appliance 1, and a data provision server 3 for storing a plurality of data associated with the home appliance 1. The data provision server 3 downloads the data selected by the user to the Java phone 2 as needed.

The Java phone 2 is a mobile communication terminal which is operated according to a Java application. The Java phone 2 includes a Java virtual machine J for executing the Java application. Further, the Java phone 2 includes a key operating panel and display panel (not shown) for enabling the user to conduct a telephone conversation over the Java phone 2.

The user can select desired control data to be downloaded to the home appliance 1 from among a plurality of home appliance control data through the use of the key operating panel and display panel of the Java phone 2. The selected control data is transferred to the home appliance 1 through a serial port S2 which is installed in the Java phone 2 to enable serial communication thereof.

If the user selects data to be transferred to the home appliance 1, then the Java phone 2 gains access to the data provision server 3 in response to a command inputted through the key operating panel, downloads the data selected by the user from the data provision server 3 and transfers it to the home appliance 1. This operation is executed in the Java phone 2 according to the Java application.

Therefore, the Java phone 2 transmits and receives data to/from the data provision server 3 wirelessly or by wire according to a typical mobile communication data transmission/reception standard using the Java application.

The Java phone 2 can be connected to the home appliance 1 by wire via the serial ports S1 and S2 to transmit and receive data to/from the home appliance 1. If the Java phone 2 is connected to the home appliance 1 by wire, then it transfers data downloaded from the data provision server 3 to the appliance 1.

It should be noted here that the same transfer applications are installed respectively in the home appliance 1 and Java phone 2 to transmit and receive data between them. In case of the home appliance 1, the transfer application is installed in a microcomputer 11 of the appliance 1 such that the microcomputer 11 controls the data transfer of the appliance 1 and converts a format of transfer data appropriately to a transfer standard.

In case of the Java phone 2, the Java application installed in the Java phone 2 supports the transfer application of the Java phone 2, thereby enabling the Java phone 2 to transmit and receive data to/from the home appliance 1 according to a transfer protocol of the transfer application.

The transfer applications are preferably applications for transmitting and receiving data according to a serial communication standard. Alternatively, the transfer applications may be applications for executing a communication protocol that a manufacturer of the home appliance 1 especially proposes for the data transfer of the appliance.

For the transfer of data between the home appliance 1 and the Java phone 2, protocols provided by the transfer applications must have the same version and data packets for the data transfer must have the same format.

For this reason, each transfer application converts a format of a packet for the data transfer between the home appliance 1 and the Java phone 2 in such a manner that the packet is composed of a protocol information field P1 including protocol information of the packet for compatibility with other protocols of different manufacturers and different products, a packet information field P2 including information regarding the packet, and a command field P3 including a command and data value to be executed by the packet, as shown in FIG. 2.

Accordingly, the Java phone 2 and the home appliance 1 transmit and receive data to/from each other through the transfer applications which convert the data into the same data packet structure. Also, the Java application of the Java phone 2 supports the transfer application of the Java phone 2, so external data can be inputted to the home appliance 1 with no necessity for setting a separate IP address in the appliance 1.

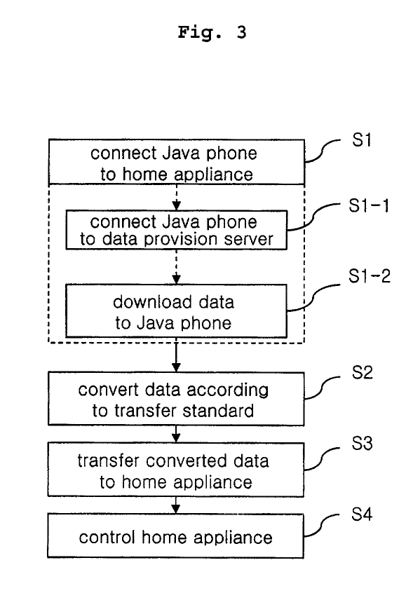

FIG. 3 is a flow chart illustrating a method for controlling the home appliance data transfer system in accordance with the present invention.

At the first step S1, a user sets a home appliance to a communication mode to input external data to the home appliance, and then connects a Java phone to the home appliance via their serial ports.

At this time, the Java phone can have home appliance control data stored therein. Otherwise, the Java phone is connected to a data provision server over the Internet or a wireless communication network at step S1-1.

The data provision server downloads data to the Java phone at step S1-2.

At the second step S2, a format of data to be transferred from the Java phone to the home appliance is converted appropriately to a transfer standard according to transfer applications of the Java phone and home appliance.

At the third step S3, the Java phone transfers the converted data to the home appliance.

At the fourth step S4, the home appliance converts the format of the transferred data based on the transfer standard appropriately to its standard using the transfer application thereof, and is then controlled according to the converted data.

As apparent from the above description, the present invention provides a home appliance data transfer system and a method for controlling the same, wherein a Java phone is connected to a home appliance via their serial ports to transmit and receive data to/from the home appliance. Control data that a user desires to input to the home appliance can be transferred to the appliance under the condition that no IP address is set in the appliance. A Java application of the Java phone supports a transfer application which converts data according to a data transfer standard of the Java phone and home appliance. Therefore, the home appliance and Java phone can transmit and receive data without collision and the user can conveniently input data to the home appliance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A home appliance data transfer system comprising:
at least one home appliance for converting data to be transmitted and received via a serial port appropriately to a transfer standard to enable data transmission/reception based on a serial communication standard; and
at least one Java phone connected to said home appliance, said Java phone having a Java application installed therein, said Java application supporting a transfer application of said Java phone which converts data to be transferred to said home appliance appropriately to said transfer standard.

2. The home appliance data transfer system as set forth in claim 1, wherein said home appliance includes:
said serial port adapted for transmitting and receiving data based on said transfer standard to/from said Java phone; and
a microcomputer having a transfer application installed therein, said transfer application converting data to be transferred via said serial port appropriately to said transfer standard.

3. The home appliance data transfer system as set forth in claim 2, wherein said transfer application installed in said microcomputer has the same version as that of said transfer application of said Java phone.

4. The home appliance data transfer system as set forth in claim 2, wherein said transfer application installed in said microcomputer converts a format of a packet of data to be transferred to said Java phone or home appliance in such a manner that said packet is composed of information regarding said packet, and a command and data value to be executed by said packet.

5. The home appliance data transfer system as set forth in claim 1, further comprising a data provision server for storing a plurality of data for control of said home appliance.

6. The home appliance data transfer system as set forth in claim 5, wherein said Java phone is connected to said data provision server over a wireless communication network to download said home appliance control data from said data provision server.

7. The home appliance data transfer system as set forth in claim 1, wherein said Java phone includes a Java virtual machine for executing said Java application in said Java phone.

8. The home appliance data transfer system as set forth in claim 1, wherein said transfer application of said Java phone converts a format of a packet of data to be transferred to said Java phone or home appliance in such a manner that said packet is composed of information regarding said packet, and a command and data value to be executed by said packet.

9. A method for controlling a home appliance data transfer system, comprising the steps of:
a) connecting at least one Java phone to at least one home appliance to input data to said home appliance;
b) converting data to be transferred from said Java phone to said home appliance appropriately to a transfer standard;
c) transferring said data converted at said step b) to said home appliance; and
d) converting said data transferred at said step c) appropriately to a standard of said home appliance and controlling said appliance according to the converted data.

10. The method as set forth in claim 9, wherein said step b) includes the step of converting a format of a packet of said data to be transferred from said Java phone in such a manner that said packet is composed of information regarding said packet, and a command and data value to be executed by said packet.
